(19) United States
(12) Patent Application Publication
(10) Pub. No.: US 2022/0072888 A1
(43) Pub. Date: Mar. 10, 2022

(54) SUBLIMATING A SUBLIMATING PRINTING SUBSTANCE

(71) Applicant: Hewlett-Packard Development Company, L.P., Spring, TX (US)

(72) Inventors: Xavier Oliva Ventayol, Sant Cugat del Valles (ES); Francisco Lopez Moral, Sant Cugat del Valles (ES); Rafael Ulacia Portoles, Sant Cugat del Valles (ES)

(73) Assignee: Hewlett-Packard Development Company, L.P., Spring, TX (US)

(21) Appl. No.: 17/417,235

(22) PCT Filed: Apr. 30, 2019
(86) PCT No.: PCT/US2019/029819

§ 371 Date: Jun. 22, 2021

(30) Foreign Application Priority Data
Feb. 6, 2019 (US) PCT/US19/16756

(51) Int. Cl. B41M 5/382; F24H 3/04

(52) U.S. Cl. CPC B41M 5/382; F24H 2250/04; F24H 3/0405

(57) ABSTRACT

Disclosed is an apparatus to generate heated air to sublimate a sublimating printing substance. The apparatus comprises: a self-regulating heating element; an air retaining device to retain air in the apparatus for heating by the self regulating heating element; and an airflow generating device arranged selectively to urge heated air to leave the retaining device. Also disclosed is a method to sublimate a sublimating printing substance deposited on a printing medium and a system to produce printing content on a printing substrate using a sublimating printing substance.

### BACKGROUND

Sublimating printing substances may be used to produce printing content on a printing substrate. For example, a sublimation printing substance may be used to print content onto fabric, garments etc. The sublimation printing content may be sublimated with the application of heat to fix the printing content onto the printing substrate.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an apparatus to generate heated air to sublimate a sublimating printing substance, according to an example;

FIG. 2 is a flow diagram of a method to sublimate a sublimating printing substance deposited on a printing medium, according to an example;

FIG. 3 is a schematic diagram of a system to produce printing content on a printing substrate using a sublimating printing substance, according to an example; and

FIG. 4 is a flow diagram of a method to produce printing content on a printing substrate using a sublimating printing substance, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in that one example, but not necessarily in other examples.

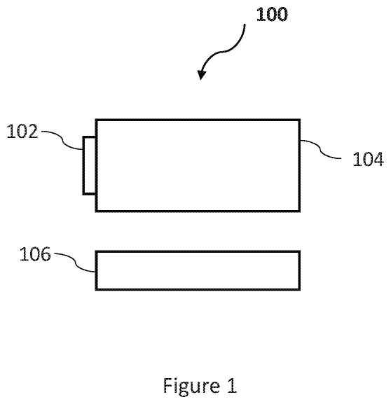

FIG. 1 schematically illustrates an apparatus 100 to generate heated air to sublimate a sublimating printing substance. The apparatus 100 comprises a self-regulating heating element 102, and an air retaining device 104 to retain air in the apparatus 100 for heating by the self-regulating heating element 102. The apparatus 100 also comprises an airflow generating device 106 arranged selectively to urge heated air to leave the air retaining device 106.

A sublimating printing substance is a substance that becomes gaseous above a sublimation temperature. The sublimation printing substance may be a substance that is solid below the sublimation temperature and becomes gaseous above the sublimation temperature. For example, the sublimation printing substance may be a sublimation dye. The sublimation printing substance may be included in a printing fluid, which can be ejected by an inkjet printer for example. The printing fluid may be liquid (e.g. in the form of an ink) and may include a suspension of sublimation printing substance particles (e.g. sublimation dye particles), for example. The sublimation temperature of the sublimating printing substance may be selected taking account of a printing substrate on which it is to be deposited. For example, the sublimation temperature may be below the melting point of the printing substrate, or constituents thereof. The sublimation temperature may also be a temperature at which the printing substrate, or its constituents, exhibit a relatively high rate of absorption of the sublimation printing substance. The sublimation printing substance may be provided in various different colors for printing on the printing substrate. The following examples are in the context of the sublimating printing substance being a sublimation dye, and, therefore, reference is made to the sublimation dye hereafter.

The printing substrate may comprise a textile, fabric, plastic, paper, and the like. For example, the printing substrate may comprise polyester fabric. The printing substrate may be in the form of a garment (e.g. a t-shirt) or a textile article such as a flag, a cushion cover, etc. The printing substrate may also be referred to as a printing medium.

The self-regulating heating element 102 may self-regulate its temperature so that it heats up towards a stable temperature and remains substantially at the stable temperature once reached. For example, the self-regulating heating element 102 may be a positive temperature coefficient heating element. The heating element 102 may comprise a positive temperature coefficient material which is a material with a positive temperature coefficient. This means that the electrical resistance of the positive temperature coefficient material increases with increasing temperature. For example, the positive temperature coefficient material may be a ceramic, e.g. a ceramic comprising barium titanate or lead titanate.

The self-regulating element 102 is hereafter referred to simply as the heating element 102. The heating element 102 may self-regulate its temperature by self-regulating the power consumption of the heating element 102 to reach the stable temperature. For example, in the case where the heating element 102 is a positive temperature coefficient heating element, electrical power (at a given potential difference) may be delivered to the heating element 102 in order to generate heat. As the temperature of the heating element 102 increases, the electrical resistance of the heating element 102 may increase. Due to the increased resistance, the heating element 102 may draw less electrical power (at that given potential difference) as the temperature increases. The heating element 102 may regulate its power consumption to a reach the stable temperature. For example, when the stable temperature is reached, the resistance of the heating element 102 may have increased such that a lower amount of electrical power is drawn to maintain the heating element 102 at the stable temperature without the electrical power drawn being enough to cause a further increase in temperature. Accordingly, when the stable temperature is reached, the electrical power consumption is lowest. The stable temperature for which the heating element 102 is designed may depend on the sublimation dye and/or the printing substrate in question. In some examples, the stable temperature of the heating element 102 may be between 180° C. and 240° C. In some examples, the stable temperature of the heating element 102 may be between 220° C. and 240° C. (which may be suitable for polyester fabrics).

The air retaining device 104 may have a physical structure which allows the air retaining device 104 to retain air in the apparatus for heating by the heating element 102. The air retaining device 104 may also be referred to as the air holding device 104. For example, the air retaining device 104 may retain air within the air retaining device 104 itself. The air retaining device 104 may be in thermal contact with the heating element 102 so that air retained in the air retaining device 104 is heated due to heat generated by the heating element 102.

The air retaining device 104 may comprise a plurality of fins to retain air in the apparatus 100. The plurality of fins may comprise a thermally conductive material. In some examples, the fins may comprise a metal such as aluminium. In some examples, other thermally conductive materials, e.g. graphene, may be used. For example, the air retaining device 104 may comprise a plurality of plates arranged parallel to each other between which air may be retained. The plurality of plates may be in thermal contact with one another. In other examples, the air retaining device 104 may be a reservoir which retains air by at least partially enclosing a volume of space.

The airflow generating device 106 may urge the heated air to leave the air retaining device 104 by generating an airflow towards the air retaining device 104, for example. The airflow generating device 106 may be a fan, for example, an electrically powered fan. The fan may comprise a plurality of blades which rotate about an axis to generate airflow. In some examples, the airflow generating device 106 may comprise two or more fans. The fan may be to generate an airflow with a speed between 0.1 m/s and 10 m/s. In some examples, the airflow generating device may urge the heated air to leave the air retaining device 104 by functioning to exhaust heated air from the air retaining device 104.

In some examples, the airflow generating device 106 may comprise a different mechanism than one or more rotating blades. For example, the airflow generating device 106 may comprise an air pushing mechanism which moves between two or more positions to urge an airflow in a desired direction. In some examples, the airflow generating device 106 may create difference in pressure by other means to urge the heated air to leave the air retaining device 104. The examples described below are in the context of the airflow generating device 106 being a fan, and hereafter reference is simply made to the fan 106.

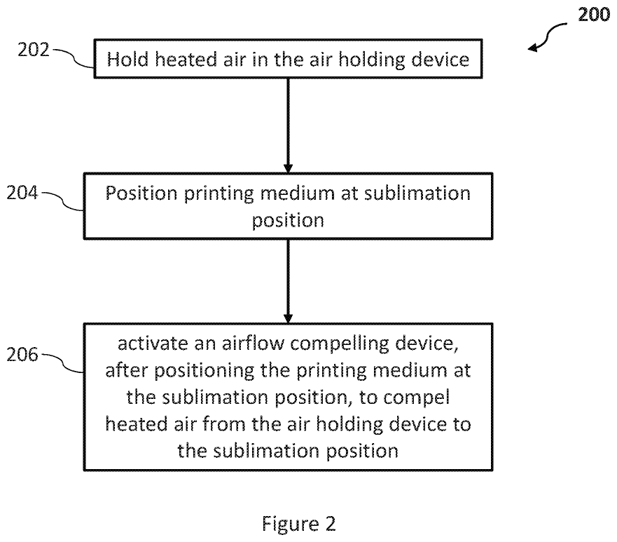

The apparatus 100 may be used in a method to sublimate a sublimation dye deposited on the printing medium. FIG. 2 is a flow diagram of a method 200 of sublimating a printing substance deposited on the printing substrate. At block 202 of the method 200, heated air is retained in the air retaining device 104. For example, the air retained by the air retaining device 104 may be heated due to heat generated by the heating element 102.

At block 204 of the method 200 the printing substrate is positioned at a sublimating position. At block 206, the fan 106 is activated, after positioning the printing substrate at the sublimating position, to compel (urge) heated air from the air retaining device 104 to the sublimation position. The airflow generating device 106 (i.e. the fan 106 of this example) may therefore also be referred to as an airflow compelling device 106. The sublimating position may be a position relative to the apparatus 100 at which the sublimation dye sublimates when the fan 106 urges heat air from the air retaining device 104 to the sublimating position. The sublimating position may be a position at which the printing substrate reaches a temperature appropriate for sublimating the sublimation dye due to the fan 106 compelling heated air from the air retaining device 104 to the sublimating position. For example, the printing substrate positioned at the sublimating position may quickly (i.e. in a matter of a second or so) reach a temperature of approximately 195° C. (based on the stable temperature of the heating element 102 being between e.g. 220° C. and 240° C.).

For example, the sublimating position may be adjacent to the air retaining device 104. The sublimating position may be such that the printing substrate is oriented to have a surface of the printing substrate substantially perpendicular to a direction in which heated air is compelled to flow by the fan 106 from the air retaining device 104. The air retaining device 104 may be between the sublimating position and the fan 106.

In some examples, the printing substrate may be positioned at the sublimating position such that a surface of the printing substrate on which the sublimation dye has been deposited faces the direction of the airflow generated by the fan 106. For example, heated air may impinge on a surface of the printing substrate opposite the surface on which the sublimation dye has been deposited. The printing substrate may be at least partially air permeable so that heated air may pass through the printing substrate. The fan may be to generate an airflow with a speed depending on how air permeable the printing substrate is, for example. During sublimation, due to the sublimation dye evaporating, there may be particles of the sublimation dye that are released close to where the sublimation dye is deposited. Such a positioning of the printing substrate may allow the airflow to remove these particles from the printing substrate.

In the example of the method 200, heated air is retained in the air retaining device 104 ready for sublimation. The fan 106 may selectively compel the heated air to leave the air retaining device 104. For example, when the printing substrate has been placed in the sublimating position, and it is desired that the sublimation process be initiated, the fan 106 may be activated.

For example, a user of the apparatus 100 may position the printing substrate at the sublimating position while heated air is held in the air retaining device 104. When the user positions the printing substrate at the sublimation position, the temperature of the retained air may be increasing towards the stable temperature, or the retained air may already be at the stable temperature (alternatively, the heating element 102 may be activated to start generating heat after the printing substrate is positioned at the sublimating position). The user may then activate the fan 106 in order to sublimate the sublimation dye deposited on the printing substrate. In one specific example, the user may position a polyester t-shirt with a sublimation dye deposited thereon at the sublimation position such that the surface with the sublimation dye faces away from the air retaining device 104. The user may then activate the fan 106, thus causing heated air to be urged from the air retaining device 104 to the polyester t-shirt so that the sublimation dye sublimates.

In some examples, the fan 106 may be activated for a predetermined period of time. The predetermined period of time may be sufficient to allow the sublimation dye to sublimate. For example, the predetermined period of time may be between 2 seconds and 10 seconds. In some examples, the predetermined period of time may be between 3 second and 5 seconds.

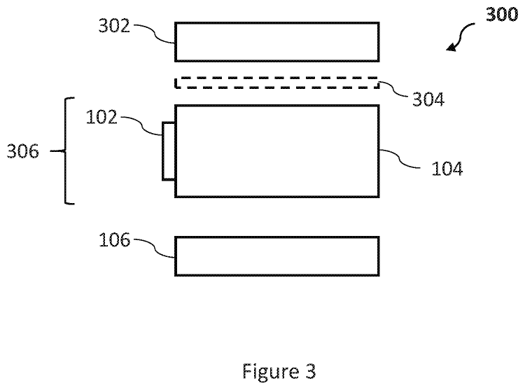

More specific details of sublimation methods and systems for sublimating the printing content are hereafter described. FIG. 3 is a schematic diagram of a system 300 to produce printing content on a printing substrate using a sublimating printing substance such as that described above. The system 300 comprises a printhead 302 to deposit the sublimating printing substance onto the printing substrate. The printhead 302 may comprise nozzles for ejecting the sublimating printing substance. The printhead 302 may be to eject the sublimating printing substance (e.g. the described sublimation dye) directly, or may eject a printing fluid (which is a liquid) including the sublimating printing substance therein, as described above.

The system 300 also comprises the apparatus 100 described above. Accordingly, the same reference numerals are used in FIG. 3 for the heating element 102, air retaining device 104 and the fan 106. In some examples, the system 300 may be provided as an integrated device. For example, the printhead 302 may be integrated with the apparatus 100 to provide the system 300. For example, the system 300 may be a sublimation printer which incorporates the printhead 302 and the apparatus 100. The form in which the system 300 is provided may vary, however, the following examples are in the context of the system 300 being a sublimation printer 300. Example features of the sublimation printer 300 which may be provided are described hereafter.

In the example of FIG. 3, the sublimation printer comprises the sublimating position 304 at which the sublimation printer 300 is to sublimate the printing substance by causing the fan 106 to urge heated air to leave the air retaining device towards the sublimating position 304. As described, the printhead 302 is to deposit sublimation dye onto the printing substrate. The sublimation printer may comprise a printing position at which the printhead 302 deposits the sublimation dye onto the printing substrate. For example, the printing substrate may be positioned at the printing position in order for the printhead 302 to deposit the sublimation dye thereon to produce printing content.

In some examples, the printing position may be substantially the same as the sublimating position 304. For example, the printing substrate may be positioned at the sublimating position 304 for the printhead 302 to deposit the sublimation dye on the printing substrate. The printhead 302 may deposit the sublimation dye while the printing substrate is positioned at the sublimating position 304, and sublimation may occur at the sublimating position 302 after the sublimation dye has been deposited without the printing substrate being substantially moved into a different position. For example, the sublimating position 304 may be in between the printhead 302 and the apparatus 100 such that opposing surfaces of the printing substrate face each of the printhead 302 and the apparatus 100.

The sublimation printer 300 may comprise a structure to hold the printing substrate in the sublimating position 304. For example, the sublimation printer 304 may comprise a frame on which the printing substrate can be positioned. Such a frame may leave opposing surfaces of the printing substrate exposed such that the sublimation dye can be deposited by the printhead 302 onto the surface facing the printhead 302, and the heated air urged by the fan 106 can impinge on the surface of the printing substrate opposite to the surface facing the printhead 302.

Therefore, the sublimation printer 300 may not use a mechanism for moving the printing substrate from a printing position into a different sublimating position, and both processes may occur at substantially the same position.

The heating element 102 and the air retaining device 104 may form a heat generating device 306 as indicated in FIG. 3. For example, the heating element 102 may be physically fixed to the air retaining device 104 such that it is in thermal contact with the air retaining device 104. However, the air retaining device 104 may be electrically isolated from the heating element 102. In some examples, a plurality of heating elements may be provided fixed (e.g. in different locations) to the air retaining device 104. In some examples, the heat generating device 306 may comprises two or more ceramic heating elements in thermal contact with a plurality of fins forming the air retaining device 104. In some examples, where the air retaining device 104 comprises a plurality of fins, the distance between adjacent fins may be selected according to the amount of air which is desired to be retained in the air retaining device 104.

In some examples, the heat generating device may be positioned between the sublimating position 304 and the fan 106. In such a configuration, the fan 106 may blow air onto the heat generating device 306 to urge heated air towards the sublimating position 304.

In some examples, the air retaining device 104 may retain air heated by the heating element 102 while the printhead deposits the sublimation dye onto the printing substrate. In some such examples, the printing position may be substantially the same as the sublimating position 304, as previously described. Therefore, heated air may be retained in the air retaining device 104 for sublimation in advance while the printhead 302 deposits the printing substance, without that the printing substrate is to be moved to a different position for sublimation. Because the air retaining device 104 retains the heated air, heat is inhibited from escaping towards the sublimating position to interfere with the deposition of the sublimation dye.

The heat generating device 306 may accumulate heat until the described stable temperature is reached. The fan 106 may be to urge heated air to leave the air retaining device 104 after the stable temperature is reached and when sublimation is desired towards the sublimating position to cause sublimation. In some examples, the stable temperature may be reached before activation of the fan 106 is desired. In such examples, the heated air may be retained at the stable temperature in the air retaining device 104 until sublimation is desired. For example, electrical power may be supplied to the heating element 102 such that the air retained in the air retaining device 104 heats. Once the stable temperature is reached, and it is desired that sublimation take place (e.g. if the process to deposit sublimation dye has completed), the fan 106 may be activated to cause sublimation of the printing material. In some examples, electrical power may continuously be supplied to the heating element 102. As described, the heating element 102 may be self-regulating and may reduce its own power consumption once the stable temperature is reached. After the heated air is removed from the heat generating device 306 due to the operation of the fan 106, the heating element 102 may draw greater electrical power to generate heat until the stable temperature is again reached. In this manner, the total power consumption may be reduced as compared to a heating mechanism which does not self-regulate its power consumption in the described manner. Continuously providing electrical power may enable the heat generating device 306 to maintain the stable temperature in readiness for sublimation while maintaining low electrical power consumption due to the above-described behavior of the heating element 102.

The fan 106 may urge heated air to leave the air retaining device 104 after the stable temperature is reached for a predetermined period of time. As described in the context of the method 200 described above, the predetermined period of time may be sufficient to allow the printing substance to sublimate (e.g. 2 seconds to 10 seconds, or, in some examples, 3 seconds to 5 seconds). In some examples, the sublimating position 304 may be at a distance relative to the heat generating device 306 such that the printing substance sublimates within 2 to 10 seconds. In some examples, the sublimating position may be between 5 mm and 25 mm away from the heat generating device 306. In some examples, the sublimation printer 300 may comprise a protective grid between the heat generating device 306 and the sublimating position 304 to avoid direct physical contact between the heat generating device 306 and the printing substrate. Such a protective grid may be air permeable so that the heated air urged by the fan 106 impinges on the printing substrate at the sublimating position 304.

The sublimation printer may comprise a processing unit and a computer readable storage medium in data communication with the processing unit. The storage medium may store instructions which, when executed by the processing unit, cause the processing unit to control the sublimation printer 300 as described above.

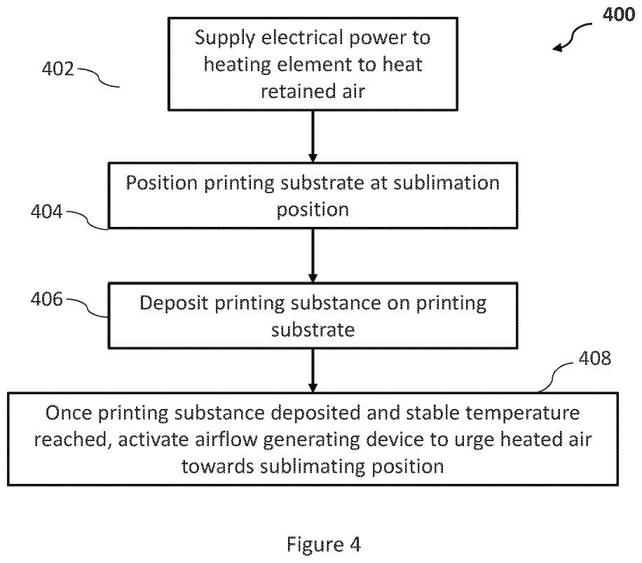

FIG. 4 is a flow diagram of a method 400 of producing printing content on the printing substrate using a sublimating printing substance. The method 400 may be performed using the sublimation printer 300 described above. At block 402 of the method 400, air retained in the air retaining device 104 is heated by supplying electrical power to the heating element 102 which causes the heating element 102 to generate heat.

At block 404, the printing substrate is positioned at the sublimating position 304. In this example, the printing position is substantially the same as the sublimating position 304. For example, the printing substrate may be positioned in the described physical structure (e.g. frame). At block 406, the sublimation dye is deposited onto the printing substance by the printhead 302 to produce printing content. For example, the printing substrate may be a piece of fabric (e.g. polyester) or a garment (e.g. polyester t-shirt), and the printhead 302 may deposit the sublimation dye to produce a pattern/image. In this example, the sublimation dye is deposited on a first surface of the printing substrate facing the printhead 302.

At block 408, once the sublimation dye has been deposited and the stable temperature gas been reached, the fan 106 is activated which causes the heated air to be urged towards the sublimating position 304. In this example, the printing position is substantially the same as the sublimating position, and the printhead 302 and the heat generating device 306 face opposing surfaces of the printing substrate. Therefore, when the fan is activated, heated air impinges a second surface, facing opposite to the first surface, of the printing substrate. In this examples, the second surface faces the heat generating device 306.

The heated air may heat the printing substrate, and pass through the printing substrate such that the sublimation dye deposited on the first surface sublimates. As described, the fan 106 may be activated for between 2 and 10 seconds (or, in some examples, between 3 seconds and 5 seconds). Such a time period may be sufficient for sublimation, for example, using the sublimation printer 300 as described. As such, in this example, a shot of heated air is delivered to the second surface (which is the back surface with respect to first surface on which the sublimation dye is deposited).

As a result of the airflow impinging on the second surface and at least partially passing through the printing substrate, excess printing substance may be lifted and removed from the first surface by the airflow. Removal of excess printing substance may avoid ghosting images, for example. The method 400 may be referred to as delivering a back air shot, since air impinges on the second surface (which is the back surface with respect to the printing substance) and is delivered for the predetermined period of time.

The order in which the blocks of the method 400 are performed may be varied from the example described above. In particular, block 402, 404 and 406 may be performed in any order. It should be noted that block 402 (supplying electrical power to the heating element 102) may be performed before, during or after block 406. As such, the deposition of the sublimation dye may occur during the time that the retained air is being heated to the stable temperature (e.g. as the temperature of the retained air is increasing due to heat generated by the heating element 102). Because the air being heated is retained in the air retaining device there may be little leakage of heat to the surrounding area. As such heating of the retained air may not interfere with the printing process taking place contemporaneously. In some examples, the retained air may reach the stable temperature during the time the sublimation dye is being deposited. In some examples, the retained air may have reached the stable temperature prior to the commencement of the process to deposit the sublimation dye.

The described examples enable the sublimation dye to be sublimated without the use of pressure being applied to the printing substrate other than any pressure due to the described airflow (e.g. pressure in a similar manner to heat presses or calendaring devices is not applied). Further, the described examples enable sublimation printing without the use of any protective papers because the sublimation dye may be deposited directly onto the printing substrate and sublimation may be performed without the use of mechanical pressure from e.g. a heat press. Not using mechanical pressure may avoid/mitigate marks on the printing substrate which may otherwise occur sue to mechanical pressure.

The described examples enable a sublimation printing process to be performed quickly and in an energy efficient manner due to the way in which heat is generated and delivered. In the described examples, heated air can be retained in advance so that heat is immediately available to be delivered for sublimation when the fan 106 is activated. Time delays relating to the time for a heating element to reach an appropriate temperature may thus be avoided or mitigated. The described examples may result in faster sublimation than in an arrangement in which airflow simply passes by a heating element because in such an arrangement, air of a lower temperature may impinge on the printing substrate, for example. Further, in such an arrangement where airflow continually passes over a heating element, the heating element may consume more electrical power than the described examples because it is continuously cooled by the airflow.

Furthermore, by retaining the heated air in the air retaining device 104, the airflow generating device 106 can be selectively operated to urge heated air to the sublimation position. This enables the printing position to be substantially the same as the sublimating position 306 (because the printing can be performed when the airflow generating device is not generating airflow), without the heat interfering with the deposition process. This means that sublimation printing is enabled without moving the printing substrate between different location for dye deposition and sublimation, without compromising printing quality. This may simplify the sublimation printer 300. Furthermore, performing deposition and sublimation in substantially the same position may avoid/mitigate the printing substrate being stained by the sublimation dye during manipulation of the printing substrate.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus to generate heated air to sublimate a sublimating printing substance, the apparatus comprising:
a self-regulating heating element;
an air retaining device to retain air in the apparatus for heating by the self-regulating heating element; and
an airflow generating device arranged selectively to urge heated air to leave the retaining device.

2. The apparatus according to claim 1, wherein the self-regulating heating element self-regulates the power consumption of the positive temperature coefficient heating element to reach a stable temperature of between 186° C. and 240° C.

3. The apparatus according to claim 1, wherein the air retaining device comprises a plurality of fins to retain air in the apparatus.

4. The apparatus according to claim 1, wherein the self-regulating heating element is a positive temperature coefficient heating element.

5. The apparatus according to claim 1, wherein the airflow generating device is a fan.

6. The apparatus according to claim 5, wherein the fan is to generate an airflow with a speed between 0.1 m/s and 10 m/s.

7. A method to sublimate a sublimating printing substance deposited on a printing medium, the method comprising:
hold heated air in an air holding device;
positioning the printing medium at a sublimation position; and
activating an airflow compelling device, after positioning the printing medium at the sublimation position, to compel heated air from the air holding device to the sublimation position.

8. The method according to claim 7, wherein the airflow inducing device is activated for a predetermined period of time between 2 seconds and 10 seconds.

9. A system to produce printing content on a printing substrate using a sublimating printing substance, the system comprising:
a printhead to deposit the sublimating printing substance onto the printing substrate;
a self-regulating heating element;
an air retaining device to retain air in the apparatus for heating by the self-regulating heating element; and
an airflow generating device arranged selectively to urge heated air to leave the retaining device.

10. The system according to claim 9 comprising a sublimating position at which the system is to sublimate the sublimating printing substance by causing the airflow generating device to urge heated air to leave the air retaining device towards the sublimating position.

11. The system according to claim 10, wherein:
the system comprises a printing position at which the printhead deposits the sublimating printing substance onto the printing substrate, the printing position being substantially the same as the sublimating position.

12. The system according to claim 11, wherein the air retaining device is to retain air heated by the self-regulating heating element while the printhead deposits the sublimating printing substance onto the printing substrate.

13. The system according to claim 10, wherein:
the self-regulating heating element and the air retaining device form a heating generation device; and
the heat generating device is positioned between the heat generating device and the sublimating position.

14. The system according to claim 13, wherein:
the heat generation device is to accumulate heat until a stable temperature is reached; and
the airflow generating device is to urge heated air to leave the air retaining device, after the stable temperature is reached and when sublimation is desired, towards the sublimating position, for a predetermined period of time, to cause sublimation.

15. The system according to claim 13, wherein the sublimating position is between 5 mm and 25 mm away from the heat generation device.
